(19) United States
(12) Patent Application Publication
(10) Pub. No.: US 2008/0281640 A1
(43) Pub. Date: Nov. 13, 2008

(54) Method For Linking Borrowers And Investors

(76) Inventor: Glen Spratt, Longueville (AU)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/660,112

(22) PCT Filed: Aug. 9, 2005
(86) PCT No.: PCT/AU2005/001186

§ 371 Date: Mar. 3, 2008

(30) Foreign Application Priority Data
Aug. 12, 2004 (AU) 2004904563
Sep. 10, 2004 (AU) 2004905211

(51) Int. Cl. G06Q 40/00; G06Q 10/00

(52) U.S. Cl. 705/4; 705/38; 705/36 R; 705/30; 705/37

(57) ABSTRACT

The present invention provides a method for linking borrowers and investors. The method comprises the step of receiving requests for loans and investments associated with borrowers and investors respectively. The method also comprises that step of associating at least one request for a loan or investment with more than one request for investment or loan, respectively, in a manner such that a loan or investment amount can be split between the investors or borrowers respectively. A condition of each loan or investment is at least to some extent determined by at least one of the borrowers and the investors.

### FIELD OF THE INVENTION

The present invention broadly relates to a method for linking borrowers and investors. Throughout this specification the term “financial institution” is used for any institution that lends money such as a bank or non-bank lending institution including for example credit unions and building societies. Further, throughout this specification the meaning of the term “investor” includes any person or institution that invests or wishes to invest funds either directly or through another person or institution. The term “borrower” includes any person or institution that borrows or wishes to borrow funds either directly or through another person or institution.

### BACKGROUND OF THE INVENTION

Almost everybody has an involvement with a financial institution such as a bank. Financial institutions lend money to borrowers and receive funds from investors. For example, a financial institution may provide a home loan and charge an interest rate. The financial institution typically also receives funds from investors, either directly or indirectly, and pays an interest rate for the received funds. In addition, customers may have an account with the financial institution, such as a bank, and dependent on the type of account, the financial institution may pay an interest rate to the customers. In any case, the interest rate which financial institutions charge for loans typically is significantly higher than the interest rate that the financial institutions pay the investors.

### SUMMARY OF THE INVENTION

The present invention provides in a first aspect a method for linking borrowers and investors, the method comprising:

receiving requests for loans and investments associated with borrowers and investors respectively,

associating at least one request for a loan or investment with more than one request for investment or loan, respectively, in a manner such that a loan or investment amount can be split between the investors or borrowers respectively,

wherein a condition of each loan or investment is at least to some extent determined by at least one of the borrowers and the investors.

The method may comprise providing at least one of the borrowers and investors with information about the condition so that the or each borrower or investor can consider the information.

The method typically also comprises providing each borrower and investor with a means for indicating that the condition is acceptable.

The investors and the borrowers typically are able to directly review requests and/or determine respective conditions without the typical intermediary, the financial institution. This has the significant advantage that margins of the financial institution can be avoided or reduced and it would be possible for the borrowers and investors to benefit from reduced charges. The borrowers and investors may operate in their own market, independent of any greater fund market.

The requests for loans and investments may be received directly from the person or institution that wishes to borrow or invest, respectively, or the requests may be received by another party, such as a mortgage broker, on behalf of the person or institution that wishes to borrow or invest.

Further, the condition of each loan or investment may at least to some extent be determined directly by the person or institution that wishes to borrow or invest or by another party, such as a mortgage broker, on behalf of the person or institution that wishes to borrow or invest.

For example, the method may provide the person or institution that wishes to borrow or invest with the option to directly accept requests by borrowers or investors, respectively, and/or to post bids for the requests by the borrowers or investors respectively. Alternatively, the method may provide another party, such as a mortgage broker, with the option to accept requests, and/or to post bids for the requests on behalf of the person or institution that wishes to borrow or invest.

In one embodiment the conditions of requests for investing funds or loans that are associated with one of the requests for a loan or investing funds respectively, differ from one another. For example, the conditions may include interest rates that differ from one another.

At least one of the borrowers and investors may be an institution, but typically the borrowers and investors are individuals. In one specific embodiment the conditions are entirely determined by the associated investors and borrowers.

The method typically is arranged for operation by an institution that is not a financial institution. The method typically comprises charging a fee, for example for posting a bid or for a successful link between respective investors and borrowers that may result in an investment/loan contract.

The method may additionally also comprise receiving more than one request from the same investor or borrower. For example, one of the borrowers or investors from whom a request was received may reconsider the condition of the request and may post a new request having a new condition.

The method typically also includes steps for effecting at least one of loan or mortgage insurance, preparation of documentation such as loan documentation, issuance of statements, settlement, discharge or enforcement of mortgages and management of loans.

In one specific embodiment of the present invention at least one of the investors is an employer and at least some of the borrowers are employees of that investor.

Alternatively, at least one of the borrows is an employer and at least some of the investors are employees of that borrower.

The method typically is computer software implemented. In this case the method may comprise providing access for the borrowers or the investors to a data server such as a data server that is accessible via the Internet. The data server typically is arranged to receive information, commands or bids from the borrowers and the investors.

The method may also comprise selecting a class for a loan. For example the loan may be classified as a mortgage, personal loan, car loan, or investment loan such as a share loan. The classification may also include classifying the loan in a sub-class such as residential mortgage, commercial mortgage or insured or uninsured mortgage.

The method may also comprise assessing a risk associated with an investment. A result of the risk assessment may be made available, for example the result may be posted on-line, so that investors can receive information about the risk associated with the investment.

Further, the method may comprise providing loan insurance, typically for a fee. In addition, the method may comprise managing loan repayments.

Further, the method may comprise receiving a payment from at least one of the borrowers and may also comprise paying loan repayments to at least one of the investors. In one embodiment receiving the payment from the or each borrower comprises receiving the payment by an appointed trustee and at least one of the investors may be repaid from a trustees account.

The present invention provides in a second aspect a computer software supported system for linking borrowers and investors, the system comprising:

a means for receiving requests for loans and investments associated with borrowers and investors respectively,

a means for associating at least one request for a loan or investment with more than one request for investment or loan, respectively, in a manner such that a loan or investment amount can be split between the investors or borrowers respectively,

wherein a condition of each loan or investment is at least to some extent determined by at least one of the borrowers and the investors.

The system may comprise a means for providing at least one of the borrowers and investors with information about the condition so that the or each borrower or investor can consider the information.

Further, the system may comprise a means for providing each borrower and investor with a means for indicating that the condition is acceptable.

The invention will be more fully understood from the following description of specific embodiments of the invention. The description is provided with reference to the accompanying drawings.

### BRIEF DESCRIPTION OF THE DRAWINGS

FIG. 1 shows a flow-chart illustrating a method for linking borrowers and investors according to an embodiment of the present invention,

FIG. 2 shows a schematic of a computer software supported system for linking borrowers and investors according to an embodiment of the present invention and

FIG. 3 (a) to 3 (c) show a flow-charts illustrating a method for linking borrowers and investors according to another embodiment of the present invention.

### DETAILED DESCRIPTION OF SPECIFIC EMBODIMENTS

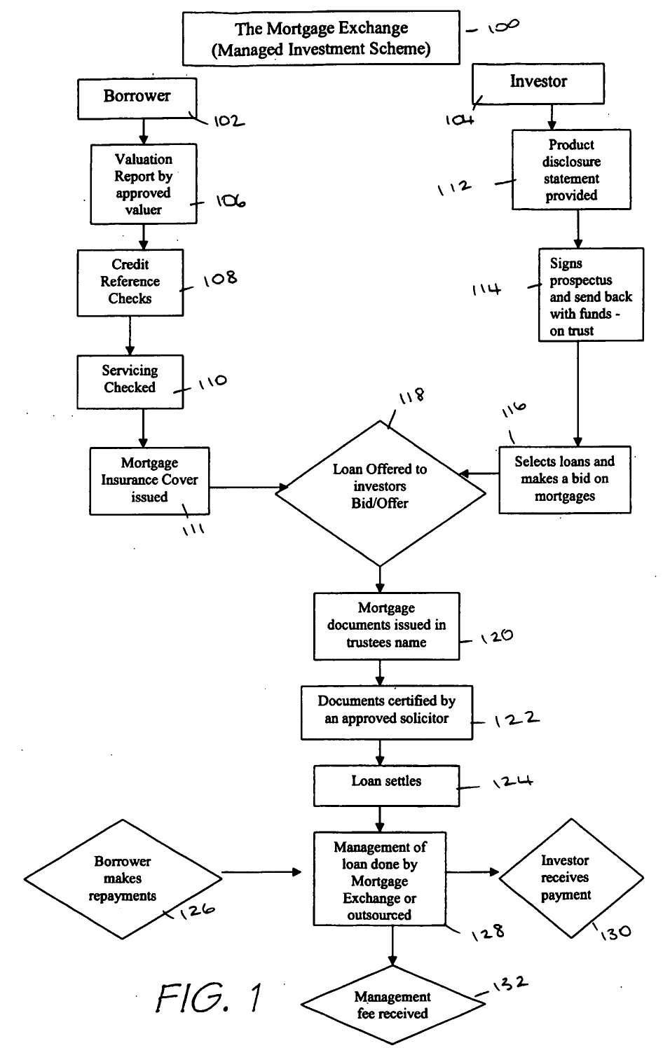

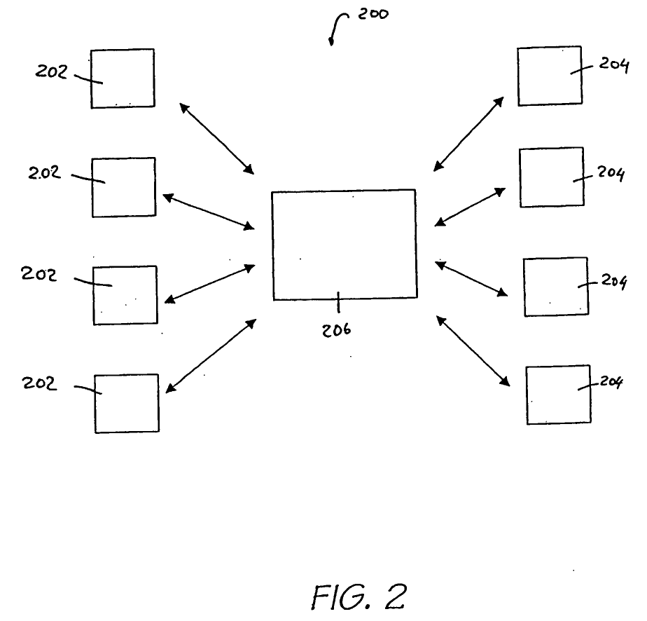

Referring to FIGS. 1 and 2 a method 100 for linking borrowers and investors and a computer software supported system 200 for linking the borrowers and investors according to embodiments of the present invention are now described. In this example the method 100 uses the system 200. The method 100 is operated by an institution for linking the investors and the borrowers and brings together borrowers directly with investors without an intermediary financial institution such as a bank.

The system 200 is arranged to receive a large number of requests for loans from borrowers 102 and a large number of requests from investors 104. Borrowers and investors may either directly or indirectly post their requests. This may be conducted using computer terminals 202 associated with the borrowers 102 and computer terminals 204 associated with investors 104. The terminals 202 and 204 are connected, for example via the Internet, to a server 206 operated by the institution for linking the investors and the borrowers. The server 206 is arranged to provide access for each of the borrowers 102 to access information related to the requests posted by investors 104. Further, the server 206 is arranged to provide access for each of the investors 104 to access information associated with the requests of the borrowers 102.

For example the server 206 may be arranged so that borrowers 102 and investors 104 can receive data by their terminals 202 or 204 and information about conditions associated with the requests, for example an interest rate, loan amount, duration of the loan and type of the loan will be displayed on the screen of the terminals 202 and 204. The borrowers 102 and investors 104 can then view and compare each other's requests and can consider if one or more of them are acceptable.

If for example a borrower 102 decides that a request by an investor 104 is acceptable, the borrower 102 may send a message to the server 206 to indicate that he wishes to accept the respective investment request. The institution for linking the investors and the borrowers may then effect a settlement between the borrower 102 and the respective investor 104. If requests by borrowers 102 or investors 104 are not acceptable, the respective borrower 102 or investor 104 who posted the request can reconsider the request, for example by comparing the request with that of other investors 104 or borrowers 104, and may post another request that is more tailored to the market's needs.

The server 206 is also equipped with a software routine that allows more than one borrower to be associated with one investor or more than one investor with one borrower in a manner such that invested funds can be split between the borrowers or a loan amount can be split between the investors respectively.

In a variation of this embodiment respective borrowers 102 and investors 104 may directly negotiate with each other via the server 206. Further, the institution for linking the investor and the borrower may not effect settlement but may simply inform prospective borrowers 102 or investors 104 that their requests have been accepted and settlement may be effected by another institution.

While the investors 104 may include investment institutions, the investors 104 typically are individuals who wish to invest their funds directly with a borrower 102 to benefit financially from the avoidance of an intermediary financial institution. The borrowers 102 typically also are individuals who wish to benefit from the avoidance of the intermediary financial institution. The institution for linking the investors and the borrowers will charge a fee for their services, such as a percentage of the interest rate that is paid by each borrower 102, but the fee typically will be significantly lower than the fee that is typically charged by a financial institution. Consequently, as the fees are reduced, borrowers and/or investors may financially benefit from the method 100.

In a variation of this embodiment the method 100 may also include the step of approaching an investor 104 or a borrower 102 with an offer from a borrower 102 or investor 104, respectively. For example, this may comprise preparing marketing material which the borrowers 102 and investors 104 may review before a bid is posted by the investors 102 or borrowers 104 for respective requests.

The loans may be any type of loans and typically are one of the following:

Fully mortgage insured 1st mortgage loans secured over residential property.

Partially mortgage insured 1st mortgage loans secured over residential property.

Uninsured 1st mortgage loans secured over residential property.

Uninsured 2nd mortgage loans secured over residential property.

Uninsured 1st mortgage loans secured over commercial property.

Uninsured 1st mortgage loans secured over industrial property.

Other classes of mortgages will also be created be sub-sets of the above (eg: lo-doc loans, credit impaired loans, high LVR loans).

Loans secured over listed shares.

Loans secured over small businesses.

Loans secured over motor vehicles.

Mortgage Insurance Investment (where a person will receive a fee for taking on all or part of the credit risk of a transaction written through the platform).

Liquidity Investment (where a person could receive a fee for providing other investors with the comfort of knowing they can redeem their investment by on selling it to them at any time).

The institution for linking the investors and the borrowers may also offer additional services. For example, such services may include valuation of assets such as homes for home loans, mortgage insurance, preparing documents and issuing any type of statements. Further, the institution may be responsible for receiving payment from the borrower, such as monthly repayments and may direct payments to the respective investors. Typically the institution will charge a fee for this service.

In a specific example the institution initially issues a valuation report by an approved valuer (step 106). Credit references and servicing are checked (steps 108 and 110) before mortgage insurance cover is issued (step 111). In this example, the institution approaches an investor 104 with a prospectus (step 102). The investor 104 then reviews the prospectus and signs documents. Funds are then transferred from the investor 104 to a trust account (step 114). The investor 104 may then select a request from a borrower and may post a bid (step 116).

Bids are then made accessible to borrowers 102 and investors 104 (step 118) and if a bid for a request by a borrower 102 or investor 104 is accepted, settlement may be effected by the institution. This includes in this example issuance of loan documents, such as mortgage documents in trustees' names (step 120). The documents are then certified by an approved solicitor (step 122) and the loan settles (step 124). The borrower 102 may then direct payments to the institution (step 126) which manages the loan (step 128). Further, the institution may forward payments to the investor (step 120) and may receive a management fee (step 132).

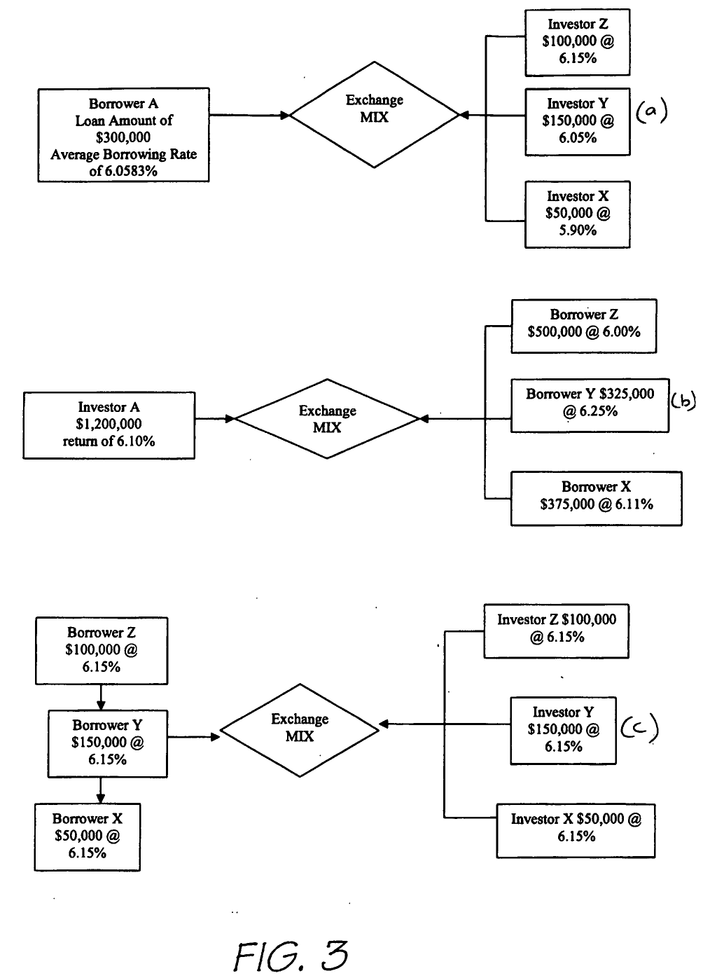

FIG. 3 (a) to 3 (c) show a flow-chart illustrating a method for linking borrowers and investors according to another embodiment of the present invention. The flow chart shown in FIG. 3 (a) illustrates an example in which a borrower A is associated with three investors X, Y and Z. In this example the software routine of the server 206, indicated as “exchange MIX”, is used to associate the borrower A with the investors X, Y and Z in a manner such that each investor receives a different interest rate and the borrower pays an average interest rate and a fee. In this example the borrower borrows $300,000 at a rate of 6.0583% and investor X invests $50,000 at a rate of 5.9%, investor Y invests $150,000 at a rate of 6.05% and investor Z invests $100,000 at a rate of 6.15%.

In the embodiment illustrated by flow-chart 3(b) one investor A is associated with three borrower X, Y and Z. In this example the software routine of the server 206, again indicated as “exchange MIX”, is used to associate the investor A with the borrowers X, Y and Z in a manner such that each borrower pays a different interest rate and the investor receives an average interest rate (the borrowers also pay a fee). In this example the investor invests $1,200,000 at a rate of 6.1% and borrower X borrows $375,000 at a rate of 6.11%, borrower Y borrows $325,000 at a rate of 6.25% and borrower Z borrows $500,000 at a rate of 6.00%.

In the embodiment illustrated by flow-chart 3(c) three borrowers are associated with three investors. In this example the software routine of the server 206 is used to associate borrowers x, Y and Z with investors X, Y and Z. In this example all borrower pay the same interest rate of 6.15% and all investors receive the same interest rate of 6.15% (the borrower also have to pay a fee). Borrower X borrows $50,000, borrower Y borrows $150,000 and borrower Z borrows $100,000. Investor X invests $50,000, investor Y invests $150,000 and investor Z invests $100,000.

In will be appreciated that in variations of the embodiments illustrated in FIGS. 3(a) to 3(c) any number of borrowers may be associated with any number of investors which may or may not pay or receive, respectively, the same interest rate.

In one example a number of loans associated with borrowers may be pooled together and the loan pool may be offered to one or more investors. A number of such pools may be formed which may be distinguished by loan characteristics such as loan/value ratio, loan insurance, loan term or loan size.

Although the invention has been described with reference to particular examples, it will be appreciated by those skilled in the art that the invention may be embodied in many other forms. For example, the investors may not be individuals or institutions but may each be a group of individuals. Further, the method may not be computer software supported. In addition, request or bids may be posted or accepted by another party, such as a mortgage broker, on behalf of the person or institution who wishes to borrow or invest. The other party would typically charge a fee.

1. A method for linking borrowers and investors, the method comprising:
receiving requests for loans and investments associated with borrowers and investors respectively,
associating at least one request for a loan or investment with more than one request for investment or loan, respectively, in a manner such that a loan or investment amount can be split between the investors or borrowers, respectively and
receiving a bid from at least one of the borrowers and the investors,
wherein a condition of each loan or investment is determined by at least one of the borrowers and the investors and wherein the borrowers and the investors are able to directly review requests.

2. The method of claim 1 wherein the borrowers are individuals.

3. The method of claim 1 wherein the investors are individuals.

4. The method of claim 1 comprising providing each borrower and investor with a means for indicating that the condition is acceptable.

5. The method of claim 1 providing the investors or borrowers with the option to accept requests by borrowers or investors respectively.

6. The method of claim 1 wherein the requests are received directly from the person or institution that wishes to borrow or invest.

7. The method of claim 1 wherein the requests are received by another party on behalf of the person or institution that wishes to borrow or invest.

8. The method of claim 7 wherein the other party is a mortgage broker.

9. The method of claim 6 wherein the condition of each loan or investment is determined directly by the person or institution that wishes to borrow or invest.

10. The method of claim 7 wherein the condition of each loan or investment is determined by the other party on behalf of the person or institution that wishes to borrow or invest.

11. The method of claim 10 wherein the other party is a mortgage broker.

12. The method of claim 1 wherein the conditions of requests for investing funds or loans that are associated with one of the requests for a loan or investing funds respectively, differ from one another.

13. The method of claim 12 wherein the conditions include interest rates that differ from one another.

14. The method of claim 1 being arranged for operation by an institution that is not a financial institution.

15. The method of claim 1 comprising charging a fee.

16. The method of claim 1 comprising receiving more than one request from the same investor or borrower.

17. The method of claim 1 comprising steps for effecting at least one of loan or mortgage insurance, preparation of documentation such as loan documentation, issuance of statements, settlement, discharge or enforcement of mortgages and management of loans.

18. The method of claim 1 wherein at least one of the investors is an employer and at least some of the borrowers are employees of that investor.

19. The method of claim 1 wherein at least one of the borrowers is an employer and at least some of the investors are employees of that borrower.

20. The method of claim 1 being computer software implemented.

21. The method of claim 20 comprising providing access for the borrowers or the investors to a data server.

22. The method of claim 1 comprising selecting a class for a loan.

23. The method of claim 22 wherein the loan is classified as a mortgage, personal loan, car loan, or investment loan such as a share loan.

24. The method of claim 22 wherein the classification comprises classifying the loan in one of the a sub-classes residential mortgage, commercial mortgage, insured mortgage or uninsured mortgage.

25. The method of claim 1 comprising assessing a risk associated with an investment.

26. The method of claim 25 wherein a result of the risk assessment is made available so that investors can receive information about the risk associated with the investment.

27. The method of claim 1 comprising providing loan insurance.

28. The method of claim 1 comprising managing loan repayments.

29. The method of claim 1 comprising receiving a payment from at least one of the borrowers.

30. The method of claim 1 comprising paying loan repayments to at least one of the investors.

31. The method of claim 1 comprising receiving a payment from at least one of the borrowers.

32. The method of claim 1 comprising receiving the payment by an appointed trustee and at least one of the investors is repaid from a trustees account.

33. A computer software supported system for linking borrowers and investors, the system comprising:
a means for receiving requests for loans and investments associated with borrowers and investors respectively,
a means for associating at least one request for a loan or investment with more than one request for investment or loan, respectively, in a manner such that a loan or investment amount can be split between the investors or borrowers, respectively and
a means for receiving a bid from at least one of the borrowers and the investors,
wherein a condition of each loan or investment is determined by at least one of the borrowers and the investors and wherein the borrowers and the investors are able to directly review requests.

34. The method of claim 1 comprising receiving the payment by an appointed trustee and at least one of the investors is repaid from a trustee account.

35. A computer software supported system for linking borrowers and investors, the system comprising:
a means for receiving requests for loans and investments associated with borrowers and investors respectively,
a means for associating at least one request for a loan or investment with more than one request for investment or loan, respectively, in a manner such that a loan or investment amount can be split between the investors or borrowers respectively,
wherein a condition of each loan or investment is at least to some extent determined by at least one of the borrowers and the investors.

36. The system of claim 35 comprising a means for providing at least one of the borrowers and investors with information about the condition so that the or each borrower or investor can consider the information.

37. The system of claim 35 comprising a means for providing each borrower and investor with a means for indicating that the condition is acceptable.
